(19) United States
(12) Patent Application Publication
(10) Pub. No.: US 2026/0136094 A1
(43) Pub. Date: May 14, 2026

(54) METHOD AND APPARATUS FOR FOCUS POSITION DETECTION OF ELECTRO-OPTICAL EQUIPMENT USING ARTIFICIAL NEURAL NETWORK

(71) Applicant: KOREA AEROSPACE RESEARCH INSTITUTE, Daejeon (KR)

(72) Inventors: Shin Wook KIM, Daejeon (KR); Young Chun YOUK, Daejeon (KR); Dong Ok RYU, Daejeon (KR)

(73) Assignee: KOREA AEROSPACE RESEARCH INSTITUTE, Daejeon (KR)

(21) Appl. No.: 19/331,951

(22) Filed: Sep. 17, 2025

(30) Foreign Application Priority Data
Nov. 14, 2024 (KR) 10-2024-0162096

(51) Int. Cl. H04N 23/67; G06V 10/774; G06V 10/82

(52) U.S. Cl. CPC H04N 23/67; G06V 10/774; G06V 10/82

(57) ABSTRACT

The present invention relates to a method and an apparatus for detecting a focus position of electro-optical equipment using an artificial neural network. A method according to the present invention comprises: generating a plurality of training images by cropping, from each of a plurality of sample target-captured images, predetermined regions including edge portions, the sample target-captured image being obtained as a single image by continuously capturing while a slanted edge target is moved along a predetermined section on an optical axis of electro-optical equipment; generating label data corresponding to each of the plurality of training images, the label data being data in which maximum slope values of a plurality of line profiles, each extracted in a direction perpendicular to an edge direction from the corresponding training image, are arranged; training an artificial neural network using a training dataset comprising the plurality of training images and the label data corresponding to the plurality of training images so that the artificial neural network outputs a focus position prediction result from an input image; and inputting, into the artificial neural network, an input image obtained by cropping to include an edge portion from an image continuously captured using target electro-optical equipment while a slanted edge target is moved along a predetermined section on an optical axis of the target electro-optical equipment, and outputting a focus position prediction result of the target electro-optical equipment.

### CROSS-REFERENCE TO RELATED APPLICATION

This application claims priority to Korean Patent Application No. 10-2024-0162096, filed in the Korean Intellectual Property Office on Nov. 14, 2024, the entire contents of which are hereby incorporated by reference.

### BACKGROUND

### Field of the Invention

The present invention relates to a method and an apparatus for detecting a focus position of electro-optical equipment, and more particularly, to a method and an apparatus for detecting a focus position of electro-optical equipment using an artificial neural network.

### Description of Related Art

In high-precision optical systems such as satellite cameras where high-resolution imaging is critical, it is very important to determine an optimal focus position. Generally, a through-focus modulation transfer function (MTF) is used to search for the focus position in an initial assembly stage so that an optical module and an image sensor can be placed at optimal positions.

Here, “through focus” refers to a process of measuring a modulation transfer function (MTF) at multiple focus positions while adjusting a focus of an optical system. That is, a target is moved along an optical axis from a distant location toward a closer location at predetermined intervals, and the MTF is repeatedly measured so that an optimal focus position can be determined based on changes in the measured values. The MTF is one of the main quality factors for evaluating spatial resolution of electro-optical equipment, and various methods for measuring the MTF exist, with an appropriate method being selected and applied according to characteristics of each industry and field.

In the field of satellite payloads, image sensors employing a push-broom scanner method are widely used. In this case, an MTF is typically measured by appropriately moving a slanted edge target during image acquisition and using edge images obtained in this process.

FIG. 1 illustrates a general process for measuring an MTF.

Referring to FIG. 1, the general process for measuring the MTF includes first obtaining an edge spread function (ESF), differentiating the ESF to obtain a line spread function (LSF), and then applying a fast Fourier transform (FFT) to the LSF to calculate the MTF.

FIGS. 2 and 3 illustrate through-focus MTF graphs that have been conventionally used to search for an optimal focus position.

The through-focus MTF conventionally used to search for an optimal focus position requires repeatedly capturing edge images at multiple focus positions and processing the acquired data to perform calculations. In the examples of FIG. 2 or FIG. 3, nine points along a Z-axis focus direction were used, and at each point, edges were captured four times by performing two forward and two backward scans, resulting in a total of 36 edge captures and MTF measurements. In this process, extensive movements of transfer devices are required for image acquisition, resulting in significant consumption of time and computational resources. In addition, temperature variations of equipment over time inevitably affect a focus of an extremely sensitive optical module, resulting in errors between an initial stage of image capture and a final stage thereof.

In addition, when vibrations in a workspace or the like affect a process of generating an ESF for MTF measurement, the ESF becomes distorted by appearing as noise. This distortion accumulates and is amplified during conversion into an LSF and an MTF, thereby causing significant variations in the MTF values. As a result, as shown in FIG. 3, a curve of the through-focus MTF may become unclear, making it impossible to use for finding an optimal focus position, and consequently requiring remeasurement.

### SUMMARY

The technical problem to be solved by the present invention is to provide a method and an apparatus for detecting a focus position of electro-optical equipment using an artificial neural network.

In order to solve the above-described technical problem, a method for detecting a focus position of electro-optical equipment using an artificial neural network according to the present invention comprises: generating a plurality of training images by cropping, from each of a plurality of sample target-captured images, predetermined regions including edge portions, the sample target-captured image being obtained as a single image by continuously capturing while a slanted edge target is moved along a predetermined section on an optical axis of electro-optical equipment; generating label data corresponding to each of the plurality of training images, the label data being data in which maximum slope values of a plurality of line profiles, each extracted in a direction perpendicular to an edge direction from the corresponding training image, are arranged; training an artificial neural network using a training dataset comprising the plurality of training images and the label data corresponding to the plurality of training images so that the artificial neural network outputs a focus position prediction result from an input image; and inputting, into the artificial neural network, an input image obtained by cropping to include an edge portion from an image continuously captured using target electro-optical equipment while a slanted edge target is moved along a predetermined section on an optical axis of the target electro-optical equipment, and outputting a focus position prediction result of the target electro-optical equipment.

The training image may be obtained by cropping, from the sample target-captured image, a region having a predetermined width to left and right of a center line of an edge portion detected in the sample target-captured image.

The predetermined section on the optical axis may include a section that is preselected as including a focus position.

The maximum slope value of each of the plurality of line profiles may be obtained by fitting a hyperbolic tangent function to each of the plurality of line profiles and by using a slope value of the hyperbolic tangent function fitted to each of the plurality of line profiles.

The artificial neural network may include an encoder in which four convolution layers are sequentially connected and a decoder in which three transposed convolution layers are sequentially connected.

The first to third convolution layers of the encoder may be connected to the third to first transposed convolution layers of the decoder, respectively, in reverse order through skip connections.

The artificial neural network may further include two convolution layers additionally connected sequentially to a rear end of the decoder.

Among the two convolution layers, a last layer may use a sigmoid activation function to normalize an output value between 0 and 1 and output the normalized value.

According to the present invention, a focus position of electro-optical equipment can be rapidly and accurately searched using a deep learning technique. Accordingly, a development period and manufacturing difficulty during initial assembly and alignment of a high-resolution electro-optical satellite payload can be remarkably reduced.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawing, in which:

FIG. 1 illustrates a general process for measuring an MTF;

FIGS. 2 and 3 illustrate through-focus MTF graphs that have been conventionally used to search for an optimal focus position;

FIG. 4 schematically illustrates a configuration of a focus position detection system for electro-optical equipment using an artificial neural network according to the present invention;

FIG. 5 is a flowchart provided to explain a focus position detection method for electro-optical equipment using an artificial neural network according to the present invention;

FIG. 6 is a diagram provided to explain a process of acquiring a sample target-captured image according to the present invention;

FIG. 7 illustratively shows a method of generating a training image according to the present invention;

FIGS. 8A to 8D are diagrams provided to explain label data generated according to one embodiment of the present invention;

FIG. 9 is a diagram illustratively showing a detailed network configuration of an artificial neural network according to one embodiment of the present invention;

FIG. 10 is a graph comparing an output and label data when test datasets are input to an artificial neural network trained according to the present invention;

FIG. 11 is a graph showing results of predicting a focus position variation according to internal temperature changes of an optical thermal vacuum chamber for each algorithm.

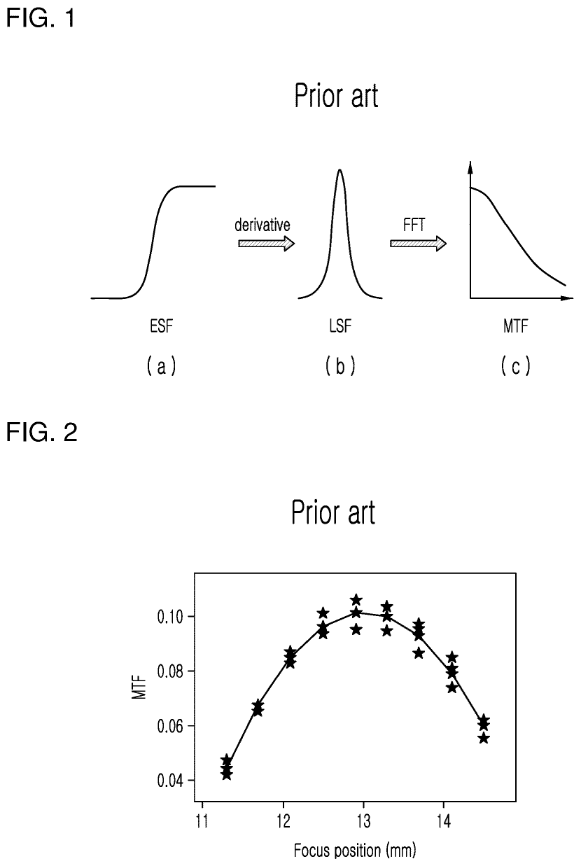

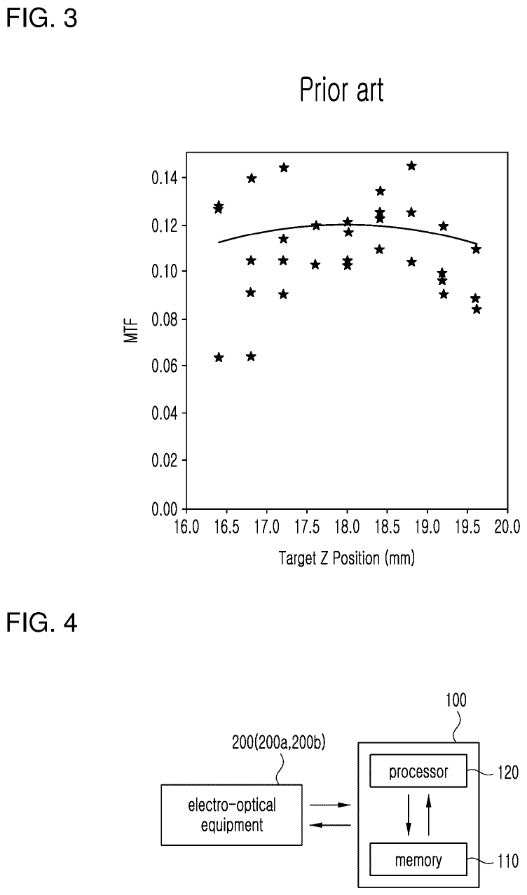

### DETAILED DESCRIPTION

Hereinafter, certain embodiments will be described in detail with reference to the accompanying drawings to help those with ordinary knowledge in the art easily achieve the present disclosure.

The terms are used herein for the purpose of describing the embodiments and not intended to limit the present disclosure. In the description, a singular expression also includes a plural expression unless specifically stated otherwise in the context. The terms “comprises” and/or “comprising” as used herein do not foreclose the presence or addition of one or more components other than the specified component. Throughout the description, the same reference numerals refer to the same components, and “and/or” includes each and combinations of one or more of the specified components. The terms “first”, “second”, etc. are used to describe various components, but it goes without saying that these components are not limited by these terms. These terms are only used to distinguish one component from another. Therefore, it goes without saying that a first component mentioned below may be a second component within the technical idea of the present disclosure.

FIG. 4 schematically illustrates a configuration of a focus position detection system for electro-optical equipment using an artificial neural network according to the present invention.

As shown in FIG. 4, a focus position detection system for electro-optical equipment using an artificial neural network according to the present invention may include focus position detection apparatus 100 and electro-optical equipment 200 (200a, 200b). Here, reference numerals 200a and 200b are used when it is necessary to distinguish between electro-optical equipment 200a used in a training process of the artificial neural network and electro-optical equipment 200b serving as a target for focus position prediction. When no distinction is required, reference numeral 200 is commonly used.

Focus position detection apparatus 100 may communicate with electro-optical equipment 200. For example, focus position detection apparatus 100 and electro-optical equipment 200 may wirelessly communicate with each other using various wireless communication technologies such as Wi-Fi, single-hop, multi-hop, and Bluetooth. In other embodiments, focus position detection apparatus 100 and electro-optical equipment 200 may be connected by wire to communicate with each other.

Focus position detection apparatus 100 may include at least one memory 110 and at least one processor 120.

Memory 110 may store at least one instruction and/or program. In addition, memory 110 may store various data used for operations related to a focus position detection method for electro-optical equipment using an artificial neural network performed in focus position detection apparatus 100. For example, memory 110 may store an artificial neural network and may also store various data required or generated in a process of constructing a training dataset for training the artificial neural network.

Processor 120 may execute instructions and/or computer programs stored in memory 110 to perform a focus position detection method for electro-optical equipment using an artificial neural network in focus position detection apparatus 100. Specifically, processor 120 may train an artificial neural network and may predict a focus position of electro-optical equipment 200 using the trained artificial neural network and output a result thereof.

Electro-optical equipment 200 may be electro-optical camera equipment or equipment including an electro-optical camera. For example, electro-optical equipment 200 may be an electro-optical payload mounted on a satellite. Hereinafter, a focus position of electro-optical equipment refers to a focus position of the electro-optical camera included in electro-optical equipment 200.

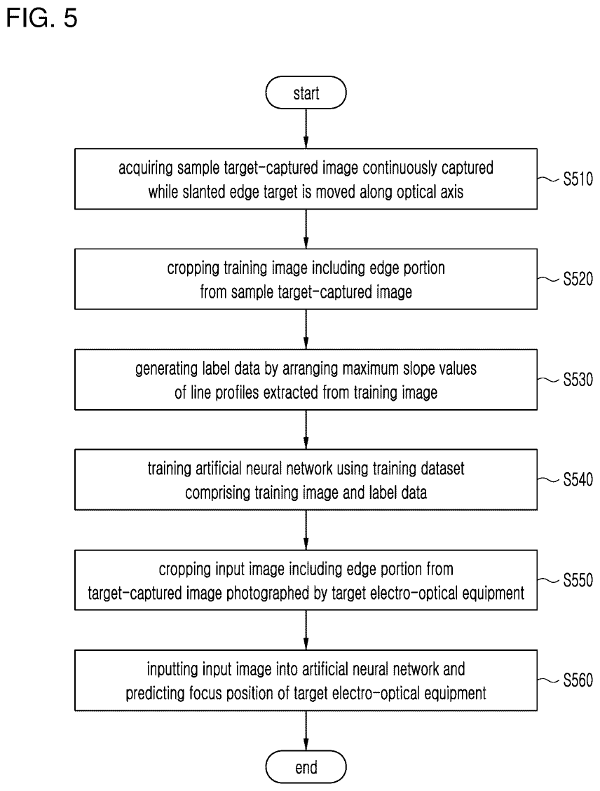

FIG. 5 is a flowchart provided to explain a focus position detection method for electro-optical equipment using an artificial neural network according to the present invention.

Referring to FIGS. 4 and 5, the focus position detection method for electro-optical equipment using an artificial neural network according to the present invention may generally be divided into a training process of an artificial neural network used for predicting a focus position of electro-optical equipment, and a prediction process of predicting a focus position of electro-optical equipment using the trained artificial neural network.

First, a sample target-captured image may be acquired by continuously capturing while a slanted edge target is moved along a predetermined section on an optical axis of electro-optical equipment 200a (S510). The slanted edge target is widely known as a target used for measuring a modulation transfer function (MTF) of an optical system.

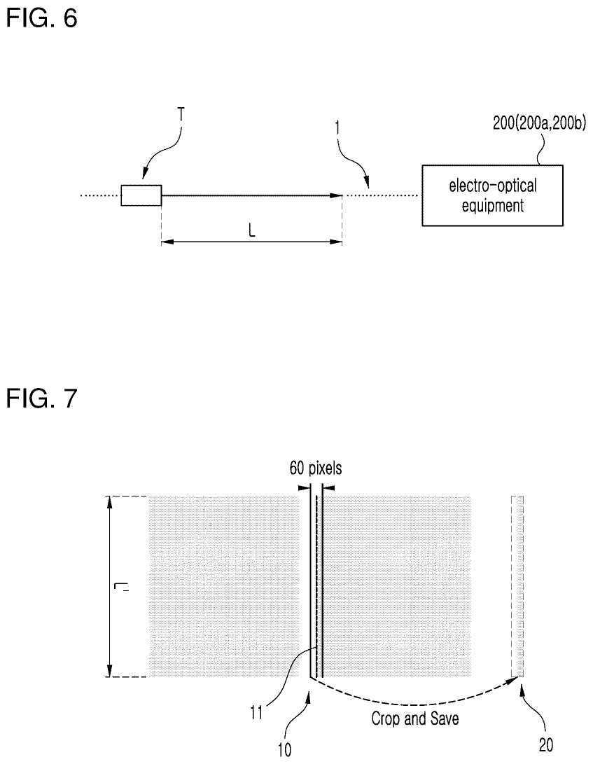

FIG. 6 is a diagram provided to explain a process of acquiring a sample target-captured image according to the present invention.

As shown in FIG. 6, a sample target-captured image may be acquired as a single image by continuously capturing while slanted edge target T is moved along predetermined section L on optical axis 1 of electro-optical equipment 200a.

In conventional approaches, edge imaging for measuring an MTF or a relative edge response (RER) was performed at multiple focus positions using a through-focus methodology. For example, edge imaging was repeatedly performed at multiple points to obtain a through-focus curve, and a peak point of the curve was selected as an optimal focus position.

In contrast, in the present embodiment, instead of selecting multiple points, the sample target-captured image may be obtained by capturing only once as a single image while slanted edge target T is continuously moved along predetermined section L on optical axis 1, where an optimal focus position is expected to exist. In step S510, a push-broom scanner-based image sensor may be used to acquire the sample target-captured image. The push-broom scanner-based image sensor may continuously capture slanted edge target T moving along optical axis 1 so that a single edge image includes edge information under various focus conditions.

The predetermined section on optical axis 1, where the optimal focus position is expected to exist, may be defined in advance as a section preselected as including the optimal focus position through expert knowledge or analysis of design values of the electro-optical equipment.

In order to acquire a plurality of sample target-captured images, step S510 may be performed multiple times for a plurality of electro-optical equipment (200a). Focus position detection apparatus 100 may obtain a plurality of sample target-captured images delivered from an image sensor.

Next, focus position detection apparatus 100 may generate a plurality of training images by cropping, from each of the plurality of sample target-captured images acquired in step S510, predetermined regions including edge portions (step S520).

FIG. 7 illustratively shows a method of generating training images according to the present invention.

As shown in FIG. 7, image 10 shows an image captured for a predetermined length section along optical axis 1 by using slanted edge target T, and illustrates a case where a right edge portion of the target is selected as a measurement subject. In image 10, L′ corresponds to predetermined section L on optical axis 1, which is continuously captured while slanted edge target T is moved.

Focus position detection apparatus 100 may detect center line 11 of an edge portion through an edge detection algorithm widely used in the field of image processing, and may crop and save, as training images, regions having a predetermined width to the left and right of center line 11 of the edge portion (for example, left and right 30-pixel regions as shown in FIG. 7).

Since the training image acquired in step S520 is a result of scanning and capturing an entire section where the optimal focus position is expected to exist at once, it may be assumed that an optimal focus position exists at an arbitrary intermediate point of the edge portion included in the training image. Label data for each of the training images may be generated using this assumption, which will be described in detail below.

Focus position detection apparatus 100 may generate label data for each of the plurality of training images cropped in step S520 (step S530).

In order to search for an optimal focus position in a training image, pixel values may be extracted line by line in a direction perpendicular to an edge direction for each of the training images, thereby generating a plurality of line profiles. A maximum slope value of each of the plurality of line profiles may then be obtained, and the maximum slope values may be arranged into a one-dimensional array to generate label data for the corresponding training image. This process may be repeated for the plurality of training images, thereby generating label data for each of the plurality of training images.

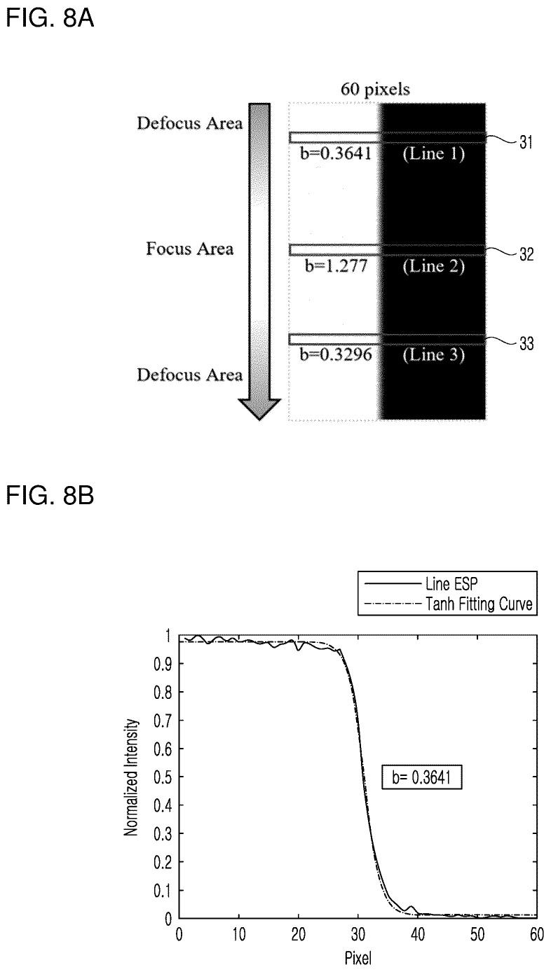

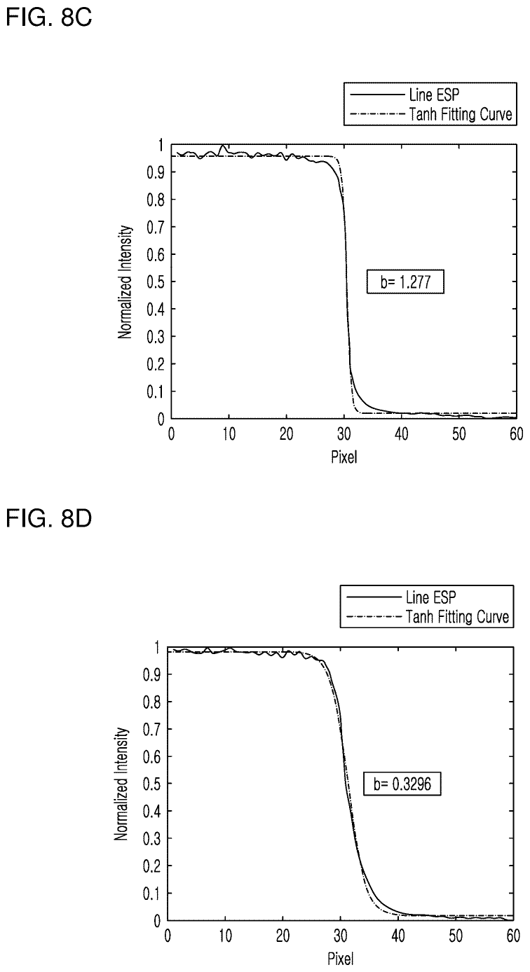

FIGS. 8A to 8D are diagrams provided to explain label data generated according to one embodiment of the present invention.

As shown in FIG. 8A, boxes 31, 32, and 33 represent some of the lines (Line 1, Line 2, Line 3) extracted line by line in a direction perpendicular to an edge direction from a training image. FIGS. 8B, 8C, and 8D show line edge spread functions (line ESFs) corresponding to line profiles corresponding to Line 1, Line 2, and Line 3, respectively, and hyperbolic tangent functions (tanh fitting curves) fitted thereto.

For example, for each of the plurality of line profiles extracted from the training image, a hyperbolic tangent function may be fitted as expressed in Equation (1), and coefficient b corresponding to a slope value of the hyperbolic tangent function fitted to each of the plurality of line profiles may be obtained.

$$f ( x ) = a \cdot tanh ( b ( x - c ) ) + d \qquad [ Equation 1 ]$$

Here, a is a coefficient corresponding to an amplitude (vertical scale) of the hyperbolic tangent function, b is a coefficient corresponding to a slope of the hyperbolic tangent function, c is a coefficient corresponding to a center position of the hyperbolic tangent function, and dis a coefficient corresponding to a vertical shift of the hyperbolic tangent function. The coefficient b of the hyperbolic tangent function represents a degree of variation in pixel values of a line profile in an edge direction in the training image.

Label data extracted in the above-described manner from a training image having a size of (3000, 60) may be generated with a size of (3000, 1).

As shown again in FIG. 8A, it can be seen that coefficient b of line profile Line 2, extracted near an optimal focus area, has the largest value of 1.277, while coefficient b of line profiles Line 1 and Line 3, extracted outside a defocus area, sharply decrease to 0.3641 and 0.3296, respectively.

As shown again in FIG. 5, focus position detection apparatus 100 may train an artificial neural network using a training dataset including the plurality of training images generated in step S530 and label data corresponding to the plurality of training images (step S540). The artificial neural network may be supervised to output a focus position prediction result using the training dataset.

The artificial neural network may be implemented using deep learning network models such as U-Net, ResNet (Residual Network), DenseNet (Densely Connected Convolutional Network), or FCN (Fully Convolutional Network).

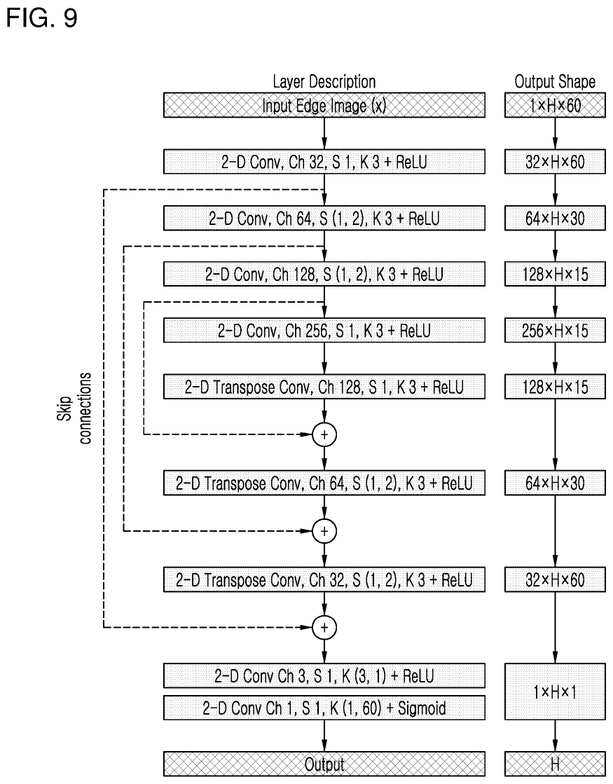

FIG. 9 illustratively shows a detailed network configuration of an artificial neural network according to one embodiment of the present invention.

As shown in FIG. 9, the artificial neural network according to the present invention may be designed to variably scan a region where an optimal focus position is likely to exist and to receive the region as an input. For example, a height (H) of an input image input to the artificial neural network may be variable depending on a capture section, and a width of the input image may be fixed to 60 pixels. In this case, regardless of the input size of the input image, the artificial neural network may be designed as a network based on a fully convolutional network (FCN) in order to search for a focus position and improve accuracy.

The artificial neural network illustrated in FIG. 9 may be implemented as a structure based on an encoder-decoder architecture, in which an input image is progressively transformed into high-level features and then restored to its original resolution. Such a structure allows features to be effectively learned while maintaining spatial information.

Specifically, the artificial neural network illustrated in FIG. 9 may include six convolution layers and three transposed convolution layers. In FIG. 9, “Ch” denotes a number of channels, “S” denotes a stride, and “K” denotes a kernel size.

In an encoder portion in which four convolution layers are sequentially connected, features of the input image may be extracted, and a resolution in a width direction may be reduced to obtain higher-level representations. In a decoder portion in which three transposed convolution layers are sequentially connected, features extracted in the encoder portion may be used to restore the resolution in the width direction and return the input image to its original resolution.

In the artificial neural network illustrated in FIG. 9, two convolution layers are additionally connected sequentially to a rear end of the decoder portion. Among the two convolution layers, a last convolution layer may be implemented to use a sigmoid activation function so as to normalize an output value for each height of an input image between 0 and 1 and output the normalized value. A height position having the highest value in a final output may be predicted as a focus position.

One of the key features of the artificial neural network structure illustrated in FIG. 9 is the use of skip connections. A skip connection connects corresponding layers between the encoder and the decoder to directly deliver features extracted in the encoder to the decoder. This helps the decoder maintain not only high-level features but also low-level detailed information.

In the artificial neural network structure illustrated in FIG. 9, the first to third convolution layers of the encoder are connected, in reverse order, to the third to first transposed convolution layers of the decoder through skip connections. For example, features extracted in the first convolution layer of the encoder are delivered to the last transposed convolution layer of the decoder, which contributes to restoring fine features of a final output image. A total of three skip connections are used in the artificial neural network structure illustrated in FIG. 9, which helps the network achieve better performance and minimize information loss during training.

Meanwhile, various loss functions may be applied to training of the artificial neural network illustrated in FIG. 9. For example, loss functions such as mean squared error (MSE), mean absolute error (MAE), and sum of absolute differences (SAD) may be applied. As a result of comparing performance of the respective loss functions, it was confirmed that the SAD-based loss function exhibited the highest prediction accuracy. This is because SAD is less sensitive to large errors, allowing stable operation even with noisy data, and the SAD loss function is advantageous in improving training efficiency of the network due to ease of interpretation and fast convergence speed.

As shown again in FIG. 5, after training of the artificial neural network is completed (step S540), focus position detection apparatus 100 may be used to predict a focus position of electro-optical equipment 200b (hereinafter, referred to as target electro-optical equipment).

First, focus position detection apparatus 100 may receive a target-captured image photographed by target electro-optical equipment 200b and may crop an input image including an edge portion (step S550).

In step S550, the target-captured image is an image continuously captured by target electro-optical equipment 200b while slanted edge target is moved along a predetermined section on optical axis of target electro-optical equipment 200b. The section in which slanted edge target is moved along optical axis may be a section preselected by a user, such as an operator or an expert, as including a focus position of target electro-optical equipment 200b, and a length of the section may be variable.

In step S550, focus position detection apparatus 100 may crop an input image including an edge portion from a target-captured image. Similar to when generating training images, focus position detection apparatus 100 may detect a center line of the edge portion in the target-captured image and may crop the input image so as to have a predetermined width to the left and right of the center line of the edge portion.

Next, focus position detection apparatus 100 may input the cropped input image of step S550 into a pre-trained artificial neural network and may output a focus position prediction result of target electro-optical equipment 200b (step S560).

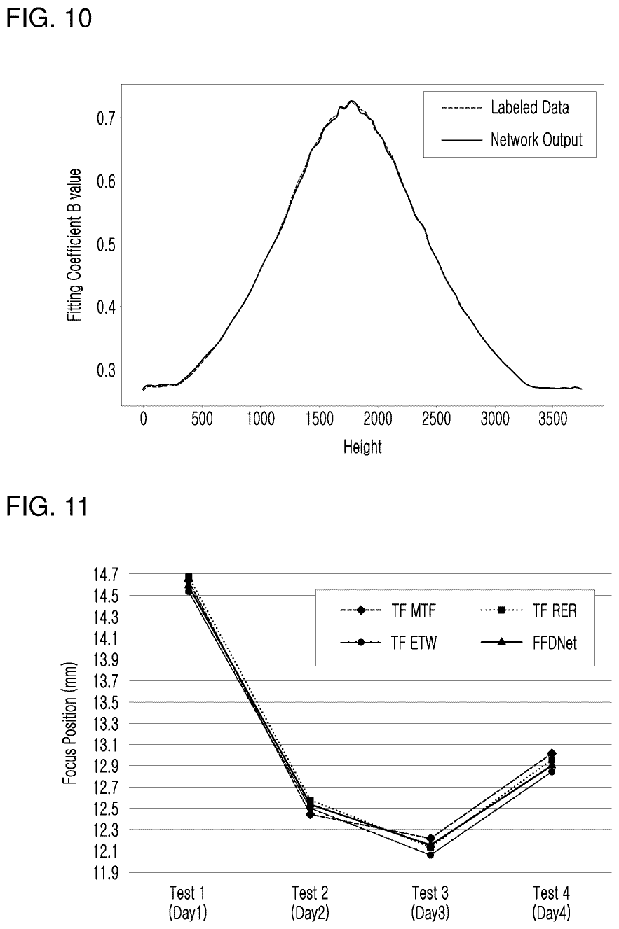

FIG. 10 is a graph comparing an output and label data when a test dataset is input to a deep learning network model trained according to the present invention.

As shown in FIG. 10, when a test image was input to the trained deep learning network model, results such as those illustrated in FIG. 10 were obtained. It was confirmed that the maximum coefficient b appeared in a middle portion of a captured focus axis, and that an optimal focus position existed near the corresponding location. It was also confirmed that an output of the trained artificial neural network accurately followed the label data.

FIG. 11 is a graph showing results of predicting a focus position variation according to internal temperature changes of an optical thermal vacuum chamber for each algorithm.

In FIG. 11, three graphs represent results of predicting a focus position by date using algorithms widely used in the related art, such as through-focus MTF (modulation transfer function), through-focus RER (relative edge response), and through-focus ETW (edge transition width). In FIG. 11, the remaining graph represents a result of predicting a focus position according to FFDNet (Fast Focus Detection Network) based on an artificial neural network devised in the present invention.

When an electro-optical camera was placed inside the thermal vacuum chamber and focus position variations were measured for three days under a vacuum state while temperature changes were applied, it was confirmed that the focus position prediction result based on the artificial neural network according to the present invention exhibited performance similar to that of conventional methods with little error.

The embodiments described above may be implemented as a hardware component, a software component, and/or a combination of a hardware component and a software component. For example, the devices, methods, and components described in the embodiments may be implemented by using one or more general computing device or specific-purpose computing device such as a processor, a controller, an arithmetic logic unit (ALU), a digital signal processor, a microcomputer, a field programmable gate array (FPGA), a programmable logic unit (PLU), a microprocessor, or any other device capable of executing instructions and responding thereto. The processing device may execute an operating system (OS) and one or more software applications executed on the operating system. Further, the processing device may access, store, operate, process, and generate data in response to the execution of software. For convenience of understanding, it is described in certain examples that one processing device is used, but one of ordinary skill in the art may understand that the processing device may include a plurality of processing elements and/or a plurality of types of processing elements. For example, the processing device may include a plurality of processors or one processor and one controller. In addition, other processing configurations such as a parallel processor are possible.

The software may include a computer program, code, instructions, or a combination of one or more of the above, and may configure the processing unit, or instruct the processing unit independently or collectively to operate as desired. Software and/or data may be interpreted by the processing device or, in order to provide instructions or data to the processing device, may be embodied in any type of machine, component, physical device, virtual equipment, computer storage medium or device, or signal wave transmission, permanently or temporarily. The software may be distributed over networked computer systems and stored or executed in a distributed manner. The software and data may be stored on one or more computer-readable recording media.

The method according to the embodiment may be implemented in the form of program instructions that can be executed through various computer means and recorded in a computer-readable medium. The computer readable medium may include program instructions, data files, data structures, and the like alone or in combination. The program instructions recorded on the medium may be those specially designed and configured for the purposes of the embodiments, or may be known and available to those skilled in computer software. Examples of computer readable recording medium include magnetic media such as hard disks, floppy disks, and magnetic tape, optical media such as CD-ROMs and DVDs, magneto-optical media such as floptical disks, and hardware devices specifically configured to store and execute program instructions such as ROM, RAM, flash memory, and the like. Examples of the program instructions include machine language codes such as those generated by a compiler, as well as high-level language codes that may be executed by a computer using an interpreter, and so on. The hardware device described above may be configured to operate as one or more software modules in order to perform the operations according to the embodiments, and vice versa.

As described above, although the embodiments have been described with reference to the limited drawings, a person of ordinary skill in the art can apply various technical modifications and variations based on the above. For example, even when the described techniques are performed in the order different from the method described above, and/or even when the components of the system, structure, device, circuit, and the like are coupled or combined in a form different from the way described above, or replaced or substituted by other components or equivalents, an appropriate result can be achieved.

1. A method for detecting a focus position of electro-optical equipment using an artificial neural network,
wherein the method is implemented on a computing device comprising at least one processor and at least one memory storing instructions or programs executable by the processor,
the method comprising:
generating a plurality of training images by cropping, from each of a plurality of sample target-captured images, predetermined regions including edge portions, the sample target-captured image being obtained as a single image by continuously capturing while a slanted edge target is moved along a predetermined section on an optical axis of electro-optical equipment;
generating label data corresponding to each of the plurality of training images, the label data being data in which maximum slope values of a plurality of line profiles, each extracted in a direction perpendicular to an edge direction from the corresponding training image, are arranged;
training an artificial neural network using a training dataset comprising the plurality of training images and the label data corresponding to the plurality of training images so that the artificial neural network outputs a focus position prediction result from an input image; and
inputting, into the artificial neural network, an input image obtained by cropping to include an edge portion from an image continuously captured using target electro-optical equipment while a slanted edge target is moved along a predetermined section on an optical axis of the target electro-optical equipment, and outputting a focus position prediction result of the target electro-optical equipment.

2. The method of claim 1, wherein the training image is obtained by cropping, from the sample target-captured image, a region having a predetermined width to left and right of a center line of an edge portion detected in the sample target-captured image.

3. The method of claim 2, wherein the predetermined section on the optical axis includes a section preselected as including a focus position.

4. The method of claim 2, wherein the maximum slope value of each of the plurality of line profiles is obtained by fitting a hyperbolic tangent function to each of the plurality of line profiles and by using a slope value of the hyperbolic tangent function fitted to each of the plurality of line profiles.

5. The method of claim 2, wherein the artificial neural network comprises an encoder in which four convolution layers are sequentially connected and a decoder in which three transposed convolution layers are sequentially connected,
and wherein first to third convolution layers of the encoder are connected, in reverse order, to third to first transposed convolution layers of the decoder through skip connections.

6. The method of claim 5, wherein the artificial neural network further comprises two convolution layers additionally connected sequentially to a rear end of the decoder,
and wherein a last one of the two convolution layers uses a sigmoid activation function to normalize an output value between 0 and 1 and output the normalized value.

7. An apparatus for detecting a focus position of electro-optical equipment using an artificial neural network,
comprising at least one processor and at least one memory,
the memory storing programs or instructions executable by the processor,
wherein, when executed by the processor, the programs or instructions cause the processor:
to generate a plurality of training images by cropping, from each of a plurality of sample target-captured images, predetermined regions including edge portions, the sample target-captured image being obtained as a single image by continuously capturing while a slanted edge target is moved along a predetermined section on an optical axis of electro-optical equipment;
to generate label data corresponding to each of the plurality of training images, the label data being data in which maximum slope values of a plurality of line profiles, each extracted in a direction perpendicular to an edge direction from the corresponding training image, are arranged;
to train the artificial neural network using a training dataset comprising the plurality of training images and the label data corresponding to the plurality of training images so that the artificial neural network outputs a focus position prediction result from an input image; and
to input, into the artificial neural network, an input image obtained by cropping to include an edge portion from an image continuously captured using target electro-optical equipment while a slanted edge target is moved along a predetermined section on an optical axis of the target electro-optical equipment, and to output a focus position prediction result of the target electro-optical equipment.

8. The apparatus of claim 7, wherein the training image is obtained by cropping, from the sample target-captured image, a region having a predetermined width to left and right of a center line of an edge portion detected in the sample target-captured image.

9. The apparatus of claim 8, wherein the predetermined section on the optical axis includes a section preselected as including a focus position.

10. The apparatus of claim 8, wherein the maximum slope value of each of the plurality of line profiles is obtained by fitting a hyperbolic tangent function to each of the plurality of line profiles and by using a slope value of the hyperbolic tangent function fitted to each of the plurality of line profiles.

11. The apparatus of claim 8, wherein the artificial neural network comprises an encoder in which four convolution layers are sequentially connected and a decoder in which three transposed convolution layers are sequentially connected,
and wherein first to third convolution layers of the encoder are connected, in reverse order, to third to first transposed convolution layers of the decoder through skip connections.

12. The apparatus of claim 11, wherein the artificial neural network further comprises two convolution layers additionally connected sequentially to a rear end of the decoder,
and wherein a last one of the two convolution layers uses a sigmoid activation function to normalize an output value between 0 and 1 and output the normalized value.
